(19) United States
(12) Patent Application Publication
(10) Pub. No.: US 2026/0126536 A1
(43) Pub. Date: May 7, 2026

(54) METHOD AND SYSTEM FOR CONTROLLING LIDAR OPERATION USING A THERMAL LENS EFFECT

(71) Applicant: Y.E. Hub Armenia LLC, Yerevan (AM)

(72) Inventors: Nikolai MURAVYOV, Moscow (RU); Dmitry NOVIKOV, Moscow (RU)

(21) Appl. No.: 19/377,292

(22) Filed: Nov. 3, 2025

(30) Foreign Application Priority Data
Nov. 2, 2024 (EA) 202492575

(51) Int. Cl. G01S 7/497; G01S 7/481; G01S 17/931

(52) U.S. Cl. CPC G01S 7/497; G01S 7/4813; G01S 7/4817; G01S 17/931; G01S 2007/4977

(57) ABSTRACT

A method for controlling a LiDAR system and a LiDAR system. The method includes directing a laminar flow of heated air over an opening window of the LiDAR system, a thermal lens effect formed due to a temperature difference between the heated air and an ambient temperature; determining one or more operational parameters of the LiDAR system or a vehicle thereof; and modifying, based on the operational parameter, a flow parameter of the laminar flow. The LiDAR system includes a window; a scanning unit and a detecting unit; a nozzle configured to direct a laminar flow of heated air over the window to induce the thermal lens effect; and a control unit configured to cause the nozzle to direct the laminar flow; determining one or more operational parameters of the LiDAR system or a vehicle equipped therewith; and modifying one or more flow parameters of the laminar flow.

### CROSS-REFERENCE

The present application claims priority to Eurasian Patent Application No. 202492575, entitled “Method and System for Controlling Lidar Operation Using a Thermal Lens Effect”, filed Nov. 2, 2024, the entirety of which is incorporated herein by reference.

### TECHNICAL FIELD

The present technology relates generally to LiDAR systems; and in particular, to a method and a system for cleaning a surface of a LiDAR system.

### BACKGROUND

Self-Driving Cars (SDCs) are vehicles that are able to autonomously drive themselves through private and/or public spaces. Using a system of sensors that detect the location and/or surroundings of the SDC, logic within or associated with the SDC controls the speed, propulsion, braking, and steering of the SDC based on the sensor-detected location and surroundings of the SDC.

A variety of sensor systems may be used by the SDC, such as but not limited to camera systems, radar systems, and LiDAR systems. Different sensor systems may be employed for capturing different information, and/or in different format, about the location and the surroundings of the SDC. For example, camera systems may be used for capturing image data about the surroundings of the SDC. In another example, LiDAR systems may be used to capture point cloud data for not only ranging objects but also building 3D map representations of the surroundings and other potential objects located in proximity to the SDC. Camera systems and LiDAR systems, amongst others, are implemented with one or more optical elements for capturing data. Weather factors such as rain and dirt may occlude optical elements of one or more sensor systems which reduces the quality of information gathered by the sensor systems for safely operating the SDC.

More specifically, LiDARs can be used in SDCs for localisation and navigation. The LiDAR collects points corresponding to light beams reflected from objects in the environment and uses these points to create a point cloud that serves as a 3D map of the environment. Different types of detection principles can be utilized in the LiDAR device, including Time-of-Flight (ToF) LiDAR, Frequency Modulated Continuous Wave (FMCW) LiDAR, etc.

Typically, the LiDAR device, which is enclosed in a housing, includes an opening window through which the light beams are emitted and received. The opening window and the sensors mounted outside the SDC are regularly exposed to elements, such as dirt and other weather contaminants. The dirt is also often mixed with chemicals or other snow-melting substances. Such contamination can negatively impact operation and/or data quality during LiDAR system use.

There thus remains a desire for improved LiDAR systems to address at least some of the above disadvantages.

### SUMMARY

Developers have devised methods and devices for overcoming at least some drawbacks present in prior art solutions.

In some embodiments of the present technology, the developers of the present technology have developed a device for cleaning a surface of a LiDAR based on the formation and control of a thermal lens effect using a laminar flow of heated air, which removes pollutants and optimizes the performance of the LiDAR system. In at least some of the non-limiting embodiments of the present technology, the LiDAR is selectively connectable to or included in an SDC.

In accordance with at least some of the non-limiting embodiments of the present technology, the method involves directing a laminar flow of heated air over the LiDAR's opening window which causes formation of a thermal lens effect due to the temperature difference between the heated air and the ambient environment. The system monitors the heated air flow temperature, ambient temperature, vehicle driving mode, and performance metrics of the LiDAR. When any of these parameters change or fall below predetermined thresholds, the system adjusts the temperature, speed, pressure, and angle of the heated air flow to modify the thermal lens effect, thereby ensuring the LiDAR system remains clean and performs optimally.

In the context of the present specification, the term “light source” broadly refers to any device configured to emit radiation such as a radiation signal in the form of a beam, for example, without limitation, a light beam including radiation of one or more respective wavelengths within the electromagnetic spectrum. In one example, the light source can be a “laser source”. Thus, the light source could include a laser such as a solid-state laser, laser diode, a high power laser, or an alternative light source such as, a light emitting diode (LED)-based light source. Some (non-limiting) examples of the laser source include: a Fabry-Perot laser diode, a quantum well laser, a distributed Bragg reflector (DBR) laser, a distributed feedback (DFB) laser, a fiber-laser, or a vertical-cavity surface-emitting laser (VCSEL). In addition, the laser source may emit light beams in differing formats, such as light pulses, continuous wave (CW), quasi-CW, and so on. In some non-limiting examples, the laser source may include a laser diode configured to emit light at a wavelength between about 650 nm and 1150 nm. Alternatively, the light source may include a laser diode configured to emit light beams at a wavelength between about 800 nm and about 1000 nm, between about 850 nm and about 950 nm, between about 1300 nm and about 1600 nm, or in between any other suitable range. Unless indicated otherwise, the term “about” with regard to a numeric value is defined as a variance of up to 10% with respect to the stated value.

In the context of the present specification, an “output beam” may be referred to as a radiation beam, such as a light beam, that is generated by the radiation source and is directed downrange towards a region of interest. The output beam may have one or more parameters such as: beam pulse duration, beam angular divergence, wavelength, instantaneous power, luminous flux at different distances from light source, average power, beam power intensity, beam width, beam repetition rate, beam sequence, pulse duty cycle, wavelength, or phase etc. The output beam may be unpolarized or randomly polarized, may have no specific or fixed polarization (e.g., the polarization may vary with time), or may have a particular polarization (e.g., linear polarization, elliptical polarization, or circular polarization).

In the context of the present specification, an “incoming beam” is radiation or light entering the system, generally after having been reflected from one or more objects in the ROI. The “incoming beam” may also be referred to as an input beam, a radiation beam, or a light beam. By reflected is meant that at least a portion of the output beam incident on one or more objects in the ROI, bounces off the one or more objects. The incoming beam may have one or more parameters including but not limited to: time-of-flight (i.e., time from emission until detection), instantaneous power (e.g., power signature), average power across entire return pulse, luminous flux distribution over return pulse period, number of reflected beams, the shape of the leading edge of the incoming beam and luminous flux distribution over return pulse period. Depending on the particular usage, some radiation or light collected in the incoming beam could be from sources other than a reflected output beam. For instance, at least some portion of the incoming beam could include light-noise from the surrounding environment (including scattered sunlight) or other light sources exterior to the present system.

In the context of the present specification, the term “surroundings” of a given vehicle refers to an area or a volume around the given vehicle including a portion of a current environment thereof accessible for scanning using one or more sensors mounted on the given vehicle, for example, for generating a 3D map of the such surroundings or detecting objects therein.

In the context of the present specification, a “Region of Interest” may broadly include a portion of the observable environment of a LiDAR system in which the one or more objects may be detected. It is noted that the region of interest of the LiDAR system may be affected by various conditions such as but not limited to: an orientation of the LiDAR system (e.g. direction of an optical axis of the LiDAR system); a position of the LiDAR system with respect to the environment (e.g. distance above ground and adjacent topography and obstacles); operational parameters of the LiDAR system (e.g. emission power, computational settings, defined angles of operation), etc. The ROI of LiDAR system may be defined, for example, by a plane angle or a solid angle. In one example, the ROI may also be defined within a certain distance range (e.g. up to 200 m or so).

In the context of the present specification, the term “laminar flow” refers to a smooth, consistent flow of air where the air moves in parallel layers with minimal turbulence. This type of airflow may be used to ensure even distribution of heat across the surface of the LiDAR's opening window.

In the context of the present specification, the term “luminous flux” refers to the total amount of light energy emitted by an optical source per unit time. Luminous flux represents the light's intensity over a given area.

In the context of the present specification, the term “scanning unit” refers to the component of the LiDAR system responsible for emitting and directing laser beams to scan the environment.

In the context of the present specification, the term “detecting unit” refers to the component of the LiDAR system that receives and analyzes the reflected laser signals. It measures the time-of-flight and intensity of the returned signals to determine the distance and characteristics of detected objects.

In the context of the present specification, the term “Field of View (FoV)” refers to the angular extent of the observable area that the LiDAR system can scan and detect at any given moment. It is defined by the angle of irradiation of the LiDAR beams, representing the total angle within which the LiDAR system can effectively capture objects in its vicinity.

In the context of the present specification, the term “range” of a LiDAR system refers to the maximum linear distance at which the LiDAR system can accurately detect and measure objects.

In the context of the present specification, the term “dioptric power” refers to the optical power of a lens or optical system that determines its ability to converge or diverge light. It is a measure of how strongly the thermal lens effect may affect the focus and range of the LiDAR system.

In the context of the present specification, the term “collimator” refers to an optical device used to align and direct the laser beam within the LiDAR system. It ensures that the emitted and detected light is collimated into a parallel beam for scanning and detection.

In the context of the present specification, the term “time-of-flight” refers to the total time it takes for a laser pulse to travel from the LiDAR system, reflect off an object, and return to the detecting unit. This measurement may be used to calculate the distance to the object.

In the context of the present specification, the term “beam pulse duration” refers to the length of time for which a laser beam pulse is emitted during an active cycle of the LiDAR system.

In the context of the present specification, the term “beam angular divergence” refers to the spread of the laser beam's angle as it travels from the LiDAR system.

In the context of the present specification, the term “beam repetition rate” refers to the frequency at which the LiDAR system emits laser pulses.

In the context of the present specification, the term “pulse duty cycle” refers to the ratio of the duration of time during which the LiDAR system is actively emitting a pulse relative to the total time of one complete cycle, including both the pulse emission and the idle period between pulses.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

According to one non-limiting implementation of the present technology, there is provided a method for controlling a LiDAR system, the LiDAR system being associated with a vehicle, the method includes directing a laminar flow of heated air over an opening window of the LiDAR system, a thermal lens effect being formed due to a temperature difference between the laminar flow of heated air and an ambient temperature; determining at least one operational parameter of at least one of the LiDAR system or the vehicle; and modifying, based on at least in part on the at least one operational parameter, at least one flow parameter of the laminar flow of heated air.

In some implementations, the at least one operational parameter comprises at least one of the ambient temperature; or a driving mode of the vehicle; or at least one performance metric of the LiDAR system.

In some implementations, the modifying the at least one flow parameter comprises modifying the at least one flow parameter in response to at least one of a change in the ambient temperature; or a change in the driving mode of the vehicle; or a change in the at least one performance metric of the LiDAR system.

In some implementations, the determining the at least one performance metric of the LiDAR system includes determining at least one of an output beam parameter; and an incoming beam parameter.

In some implementations, the method further includes determining at least one output beam parameter, the at least one output beam parameter comprising at least one of: an output beam pulse duration; or an output beam angular divergence; or an instantaneous power; or a luminous flux at one or more distances from a light source in the LiDAR system; or an average beam power; or an output beam power intensity; or an output beam width; or an output beam repetition rate; or an output beam sequence; or a pulse duty cycle; or a beam wavelength.

In some implementations, the method further includes determining at least one incoming beam parameter, the at least one incoming beam parameter comprising at least one of: a time-of-flight; or an incoming beam instantaneous power; or an average power across return pulses; or a luminous flux distribution over return pulse period; or a number of reflected beams; or a shape of the leading edge of the incoming beam.

In some implementations, the modifying the at least one flow parameter includes determining the at least one operational parameter over a period of time; and modifying the at least one flow parameter in response to a change in the at least one operational parameter during the period of time.

In some implementations, the at least one operational parameter includes at least one of: the ambient temperature; or a driving mode of the vehicle; or at least one performance metric of the LiDAR system; and the modifying the at least one flow parameter comprises modifying the at least one flow parameter in response to at least one of: a change in the ambient temperature during the period of time; or a change in the driving mode of the vehicle during the period of time; or a change in the at least one performance metric of the LiDAR system during the period of time.

In some implementations, the modifying the at least one flow parameter comprises modifying at least one of: a temperature of the laminar flow of heated air; or an air speed of the laminar flow of heated air; or an air pressure of the laminar flow of heated air; or an angle of flow of the laminar flow of heated air; or a width of flow of the laminar flow of heated air.

In some implementations, the driving mode includes at least one of: speed variations of the vehicle; or traffic patterns; or characteristics of driving routes.

In some implementations, the method further includes increasing a temperature difference between the laminar flow of heated air and the ambient temperature to widen a field of view of the LiDAR system for close-range detection mode.

In some implementations, the method further includes decreasing a temperature difference between the laminar flow of heated air and the ambient temperature to extend a detection range of the LiDAR system for a long-range detection mode.

According to one non-limiting implementation of the present technology, there is provided a LiDAR system including a housing including an opening window; a scanning unit and a detecting unit disposed in the housing; a nozzle configured to direct a laminar flow of heated air over the opening window to induce a thermal lens effect due to a temperature difference between the laminar flow of heated air and an ambient temperature; and a control unit operatively connected to the nozzle, the control unit being configured to: cause the nozzle to direct the laminar flow of heated air over the opening window; determining at least one operational parameter of at least one of the LiDAR system or a vehicle equipped with the LiDAR system; and modifying, based at least in part on the at least one operational parameter, at least one flow parameter of the laminar flow of heated air.

In some implementations, the LiDAR system further includes at least one sensor for determining the at least one operational parameter.

In some implementations, the at least one sensor includes an ambient temperature sensor and an incoming air flow velocity sensor.

In some implementations, the control unit is further configured to modify the at least one flow parameter by modifying at least one of: a temperature of the laminar flow of heated air; or an air speed of the laminar flow of heated air; or an air pressure of the laminar flow of heated air; or an angle of flow of the laminar flow of heated air; or a width of flow of the laminar flow of heated air.

In some implementations, the control unit is further configured to increase a temperature difference between the laminar flow of heated air and the ambient temperature to widen a field of view of the LiDAR system for close-range detection mode.

In some implementations, the control unit is further configured to decrease a temperature difference between the laminar flow of heated air and the ambient temperature to extend a detection range of the LiDAR system for a long-range detection mode.

In some implementations, the control unit is further configured to determine the at least one operational parameter by determining at least one of: the ambient temperature; or a driving mode of the vehicle equipped with the LiDAR system; or at least one performance metric of the LiDAR system.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a LiDAR system, in accordance with certain non-limiting embodiments of the present technology.

FIG. 2 depicts a schematic diagram of a controller for implementing certain embodiments of the present technology.

FIG. 3 depicts a schematic diagram of a networked computing environment being suitable for use with certain non-limiting embodiments of the present technology.

FIG. 4 depicts a flowchart illustrating an example method for controlling a LiDAR system in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or “controller”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

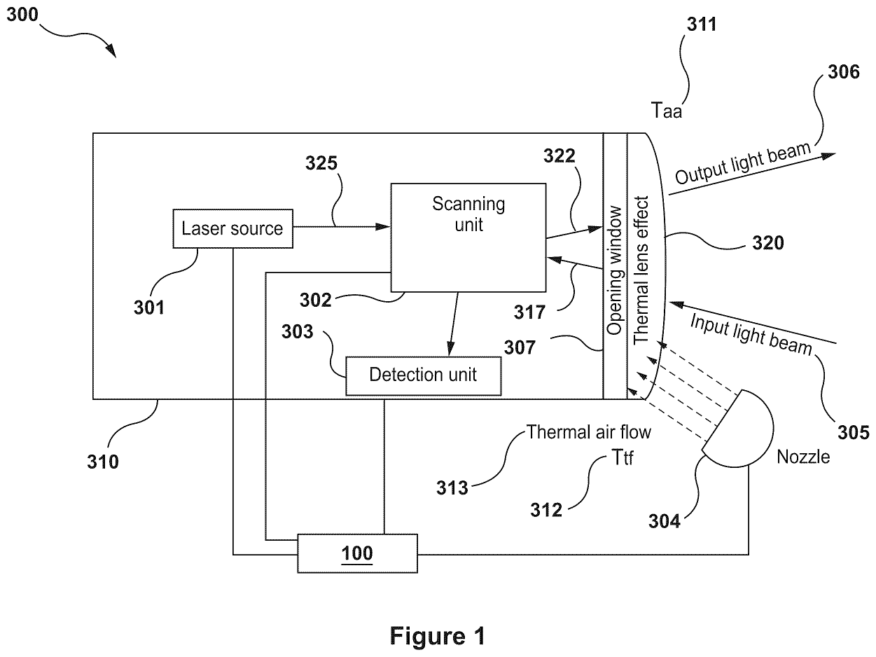

With reference to FIG. 1, there is depicted a LiDAR system 300 with a thermal lens effect induced by a laminar flow of heated air over the LiDAR system's opening window, in accordance with certain non-limiting embodiments of the present technology.

In the context of the present specification, the term “thermal lens” or ““thermal lens effect”” refers to a lens effect created by a temperature gradient in the air that alters the optical properties of the air having the temperature gradient. This effect may be utilized to adjust the optical characteristics of the LiDAR system by modifying the refraction of light through the heated air and into or out of an operational window thereof.

The LiDAR system 300 includes a laser source 301, a scanning unit 302, and a detection unit 303. The laser source 301, the scanning unit 302, and the detection unit 303 are disposed within a main body 310, also referred to as a housing 310. The LiDAR system 300 includes an opening window 307 defined at least in part by the housing 310. During operation of the LiDAR system 300, light from the laser source 301 exits the housing 310 through the window 307 and reflected light from the environment is received by the detection unit 303 via the window 307.

The LiDAR system 300 further includes a nozzle 304 mounted outside the opening window 307 of the LiDAR housing 310. The nozzle 304 directs a laminar flow of heated air 313 over the opening window 307. The laminar flow of heated air 304 cleans the surface of the opening window 307 by removing accumulated pollutants or debris from the surface.

By using heated air, the laminar flow further creates a thermal lens effect 320 that may be controlled to aid or correct operation of the LiDAR system 300. The thermal lens effect 320 is formed due to the difference between the temperature 312 (T_{tf}) of the heated air flow 313 and the temperature 311 of the ambient atmosphere (Tₐₐ) outside the LiDAR system 300. Control and use of the thermal lens effect is described in more detail below.

Operation of the LiDAR system 300 generally proceeds as follows. The laser source 301 generates a laser beam 325 that is directed towards the scanning unit 302. The scanning unit 302 controls the direction and distribution of the laser beam 322, emitting it through the opening window 307 and the thermal lens effect 320, thereby forming the output light beam 306. The output light beam 306 gets reflected by objects in the vicinity (not shown in FIG. 1) and returns to the thermal lens effect 320 as the incoming light beam 305. After being refracted through the thermal lens effect 320 and the opening window 307, the incoming light beam 305 reaches the scanning unit 302 as beam 317. The scanning unit 302 aligns the beam 317 towards the detection unit 303, which analyzes the beam 317 to gather information about the distance, shape, and other characteristics of the objects based on the time-of-flight and intensity of the reflected light.

The LiDAR system 300 includes a controller 100 communicatively connected to the laser source 301, the scanning unit 302, and the detection unit 303. The controller 100 provides instructions to and receives information from the components 301, 302, 303 in order to operate the system 300 and to receive the imaging output therefrom. Details of the controller 100 are set out below.

The controller 100 is further operatively connected to the nozzle 304. The controller 100 is configured to cause the nozzle 304 to direct the laminar flow of heated air 313 over the opening window 307. The controller 100 is also configured to determine the operational parameters of the LiDAR system 300 and information relating to a vehicle 220 equipped with the system 300 using sensors and modify, based on this information, the flow parameters of the laminar flow of heated air 313. The vehicle 220 as equipped with the LiDAR system 300 is described in more detail below.

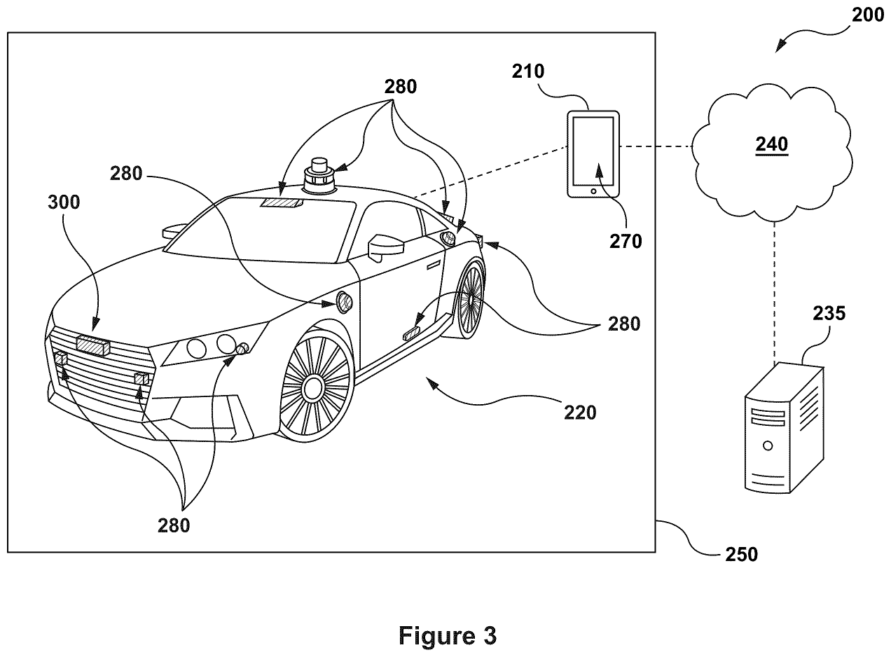

The LiDAR system 300 includes a variety of sensors (not shown) communicatively connected to the controller 100. Examples of sensors used by the system 300 may include an ambient temperature sensor, and an incoming air flow velocity sensor. The sensors monitor various parameters of the system 300, including but not limited to: the temperature 311 of the ambient atmosphere (Tₐₐ), the temperature 312 (T_{tf}) of the heated air flow 313, one or more performance metrics of the LiDAR system 300, and different driving modes of a vehicle 220 (FIG. 3) equipped with the LiDAR system 300. Based on information derived or received from the sensors, the controller 100 can then adjust operation of the LiDAR system 300, including by controlling the nozzle 304 to change the air flow characteristics.

These performance metrics of the LiDAR system 300 can include output beam parameters such as beam pulse duration, beam angular divergence, instantaneous power, luminous flux at different distances from the light source, average power, beam power intensity, beam width, beam repetition rate, beam sequence, pulse duty cycle, and wavelength etc.

These performance metrics of the LiDAR system 300 can also include incoming beam parameters such as time-of-flight, instantaneous power, average power across the return pulse, luminous flux distribution over the return pulse period, number of reflected beams, and the shape of the leading edge of the incoming beam.

The sensors also monitor the driving mode of the vehicle 220, including variations in speed, traffic conditions, and route types etc. Examples of different driving modes of the vehicle 220 may include a city mode with close-range observation and a highway mode with long-range observation. In the city mode, the vehicle 220 may not require a long distance of observation; instead, the focus of the LiDAR system 300 may be on detecting pedestrians and objects close to the vehicle 220. Conversely, in the highway mode, the LiDAR system 300 may need to scan over longer distances more frequently to facilitate high-speed travel for the vehicle 220.

Flow parameters of the laminar flow of heated air 313 that may be controlled or adjusted by the controller 100 include but are not limited to: the temperature of the heated air, the speed of the air flow, the pressure of the air flow, the angle of the air flow, and the width of the air flow.

Several parameters of the thermal lens effect 320 impact the range of the laser irradiation and the angle of the irradiation (Field of View, or FoV) of the LiDAR system 300. Some such parameters include thickness (along the optical axis) and radius of curvature of the temperature of the heat gradient zone of the laminar flow. The parameters of the thermal lens effect 320 affect its dioptric power, i.e., the degree to which the thermal lens effect 320 can converge or diverge light. These parameters are taken into account by the controller 100 for determining the performance metrics of the LiDAR system 300. Additionally, the parameters of the thermal lens effect 320 are considered while configuring or assembling the LiDAR system 300, including adjusting the location and characteristics of various lenses and the collimator (not shown) of the laser source 301.

Since the thermal lens effect 320 is formed due to the difference (ΔT) between the temperature 312 (T_{tf}) of the heated air flow 313 and the temperature 311 of the ambient atmosphere (Tₐₐ), the temperature 312 (T_{tf}) of the heated air flow 313 significantly affects the lateral extent of the thermal lens effect 320 along the direction corresponding to the width of the window. A higher ΔT results in a wider FoV and a shorter range of observation, which may be suitable for close-range detection. A lower ΔT results in a narrower FoV and a longer range of observation, which may be suitable for long-range detection.

It is contemplated that other flow parameters of the laminar flow of heated air 313, for example, the speed of the air flow, the pressure of the air flow, the angle of the air flow, and the width of the air flow etc. may also be used by the controller 100 to modify the parameters of the thermal lens effect 320 and thus the operation of the LiDAR system 300.

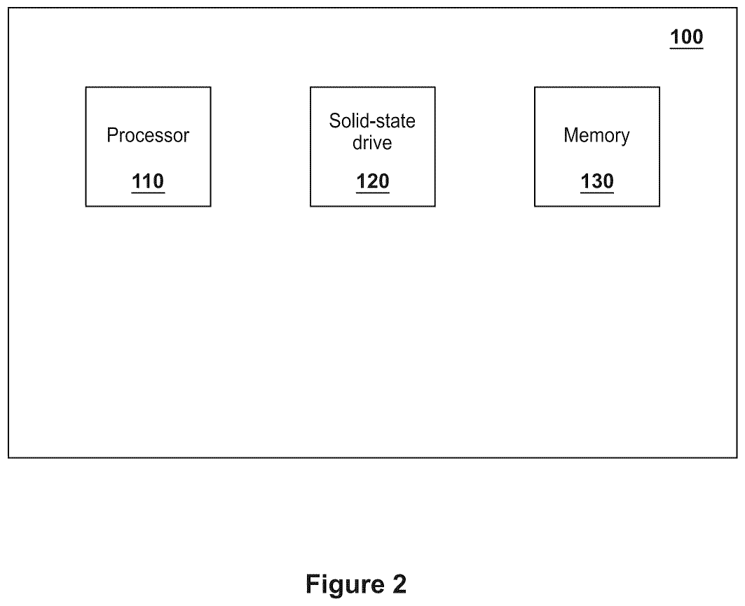

Referring to FIG. 2, there is depicted a schematic diagram of a computer system 100 suitable for use with some implementations of the present technology, generally referred to herein as the controller 100 or control unit 100. The controller 100 includes various hardware components including one or more single or multi-core processors collectively represented by a processor 110, a solid-state drive 120, and a memory 130, which may be a random-access memory or any other type of memory.

Communication between the various components of the control unit 100 may be enabled by one or more internal and/or external buses (not shown) (e.g. a PCI bus, universal serial bus, IEEE 1394 “Firewire” bus, SCSI bus, Serial-ATA bus, etc.), to which the various hardware components are electronically coupled. According to embodiments of the present technology, the solid-state drive 120 stores program instructions suitable for being loaded into the memory 130 and executed by the processor 110 for determining a presence of an object. For example, the program instructions may be part of a vehicle control application executable by the processor 110. It is noted that the controller 100 may have additional and/or optional components (not depicted), such as network communication modules, localization modules, and the like.

In some embodiments, the controller 100 may be implemented by any of a conventional personal computer, a controller, and/or an electronic device (e.g., a server, a controller unit, a control device, a monitoring device etc.) and/or any combination thereof appropriate to the relevant task at hand. In some other embodiments, the controller 100 may be an “off the shelf” generic computer system. In some embodiments, the controller 100 may also be distributed amongst multiple systems. The controller 100 may also be specifically dedicated to the implementation of the present technology. As a person in the art of the present technology may appreciate, multiple variations as to how the controller 100 is implemented may be envisioned without departing from the scope of the present technology.

With reference to FIG. 3, there is depicted a networked computing environment 200, including the vehicle 220, suitable for use with some non-limiting embodiments of the LiDAR system 300. The networked computing environment 200 includes an electronic device 210 associated with a vehicle 220 and/or associated with a user (not depicted) who is associated with the vehicle 220 (such as an operator of the vehicle 220). The environment 200 also includes a server 235 in communication with the electronic device 210 via a communication network 240 (e.g. the Internet or the like, as will be described in greater detail herein below).

In at least some non-limiting embodiments of the present technology, the electronic device 210 is communicatively coupled to control systems of the vehicle 220. The electronic device 210 could be arranged and configured to control different operations systems of the vehicle 220, including but not limited to: an ECU (engine control unit), steering systems, braking systems, and signaling and illumination systems (i.e. headlights, brake lights, and/or turn signals). In such an embodiment, the vehicle 220 could be a self-driving vehicle 220.

In some non-limiting embodiments of the present technology, the networked computing environment 200 could include a GPS satellite (not depicted) transmitting and/or receiving a GPS signal to/from the electronic device 210. It will be understood that the present technology is not limited to GPS and may employ a positioning technology other than GPS. It should be noted that the GPS satellite can be omitted altogether.

The vehicle 220, to which the electronic device 210 is associated, could be any transportation vehicle, for leisure or otherwise, such as a private or commercial car, truck, motorbike or the like. Although the vehicle 220 is depicted as being a land vehicle, this may not be the case in each and every non-limiting embodiment of the present technology. For example, in certain non-limiting embodiments of the present technology, the vehicle 220 may be a watercraft, such as a boat, or an aircraft, such as a flying drone.

The vehicle 220 may be user operated or a driver-less vehicle. In some non-limiting embodiments of the present technology, it is contemplated that the vehicle 220 could be implemented as a Self-Driving Car (SDC). It should be noted that specific parameters of the vehicle 220 are not limiting, these specific parameters including for example: vehicle manufacturer, vehicle model, vehicle year of manufacture, vehicle weight, vehicle dimensions, vehicle weight distribution, vehicle surface area, vehicle height, drive train type (e.g. 2× or 4×), tire type, brake system, fuel system, mileage, vehicle identification number, and engine size.

According to the present technology, the implementation of the electronic device 210 is not particularly limited. For example, the electronic device 210 could be implemented as a vehicle engine control unit, a vehicle CPU, a vehicle navigation device (e.g. TomTom™, Garmin™), a tablet, a personal computer built into the vehicle 220, and the like. Thus, it should be noted that the electronic device 210 may or may not be permanently associated with the vehicle 220. Additionally or alternatively, the electronic device 210 could be implemented in a wireless communication device such as a mobile telephone (e.g. a smart-phone or a radio-phone). In certain embodiments, the electronic device 210 has a display 270.

The electronic device 210 could include some or all of the components of the control unit 100 depicted in FIG. 2, depending on the particular embodiment. In certain embodiments, the electronic device 210 is an on-board computer device and includes the processor 110, the solid-state drive 120 and the memory 130. In other words, the electronic device 210 includes hardware and/or software and/or firmware, or a combination thereof, for processing data as will be described in greater detail below.

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the electronic device 210 and the communication network 240, the implementation of which will depend, inter alia, on how the electronic device 210 is implemented. Merely as an example and not as a limitation, in those non-limiting embodiments of the present technology where the electronic device 210 is implemented as a wireless communication device such as a smartphone or a navigation device, the communication link can be implemented as a wireless communication link. Examples of wireless communication links may include, but are not limited to, a 3G communication network link, a 4G communication network link, and the like. The communication network 240 may also use a wireless connection with the server 235.

In some embodiments of the present technology, the server 235 is implemented as a computer server and could include some or all of the components of the control unit 100 of FIG. 2. In one non-limiting example, the server 235 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 235 is a single server. In alternative non-limiting embodiments of the present technology, the functionality of the server 235 may be distributed and may be implemented via multiple servers (not shown).

In some non-limiting embodiments of the present technology, the processor 110 of the electronic device 210 could be in communication with the server 235 to receive one or more updates. Such updates could include, but are not limited to, software updates, map updates, routes updates, weather updates, and the like. In some non-limiting embodiments of the present technology, the processor 110 can also be configured to transmit to the server 235 certain operational data, such as routes travelled, traffic data, performance data, and the like. Some or all such data transmitted between the vehicle 220 and the server 235 may be encrypted and/or anonymized.

It should be noted that a variety of sensors and systems may be used by the electronic device 210 for gathering information about surroundings 250 of the vehicle 220. As seen in FIG. 3, the vehicle 220 may be equipped with a plurality of sensor systems 280. It should be noted that different sensor systems from the plurality of sensor systems 280 may be used for gathering different types of data regarding the surroundings 250 of the vehicle 220.

In one example, the plurality of sensor systems 280 may include various optical systems including, inter alia, one or more camera-type sensor systems that are mounted to the vehicle 220 and communicatively coupled to the processor 110 of the electronic device 210. Broadly speaking, the one or more camera-type sensor systems may be configured to gather image data about various portions of the surroundings 250 of the vehicle 220. In some cases, the image data provided by the one or more camera-type sensor systems could be used by the electronic device 210 for performing object detection procedures. For example, the electronic device 210 could be configured to feed the image data provided by the one or more camera-type sensor systems to an Object Detection Neural Network (ODNN) that has been trained to localize and classify potential objects in the surroundings 250 of the vehicle 220.

In another example, the plurality of sensor systems 280 could include one or more radar-type sensor systems that are mounted to the vehicle 220 and communicatively coupled to the processor 110. Broadly speaking, the one or more radar-type sensor systems may be configured to make use of radio waves to gather data about various portions of the surroundings 250 of the vehicle 220. For example, the one or more radar-type sensor systems may be configured to gather radar data about potential objects in the surroundings 250 of the vehicle 220, such data potentially being representative of a distance of objects from the radar-type sensor system, orientation of objects, velocity and/or speed of objects, and the like.

In a further example, the plurality of sensor systems 280 could include one or more Light Detection and Ranging (LiDAR) systems that are mounted to the vehicle 220 and communicatively coupled to the processor 110, in addition to the LiDAR system 300 described above. The LiDAR system 300 could be mounted, or retrofitted, to the vehicle 220 in a variety of locations and/or in a variety of configurations for gathering information about surroundings 250 of the vehicle 220.

For example, depending on the implementation of the vehicle 220 and the LiDAR system 300, the LiDAR system 300 could be mounted on an interior, upper portion of a windshield of the vehicle 220. Nevertheless, other locations for mounting the LiDAR system 300 are within the scope of the present disclosure, including on a back window, side windows, front hood, rooftop, front grill, front bumper or the side of the vehicle 220.

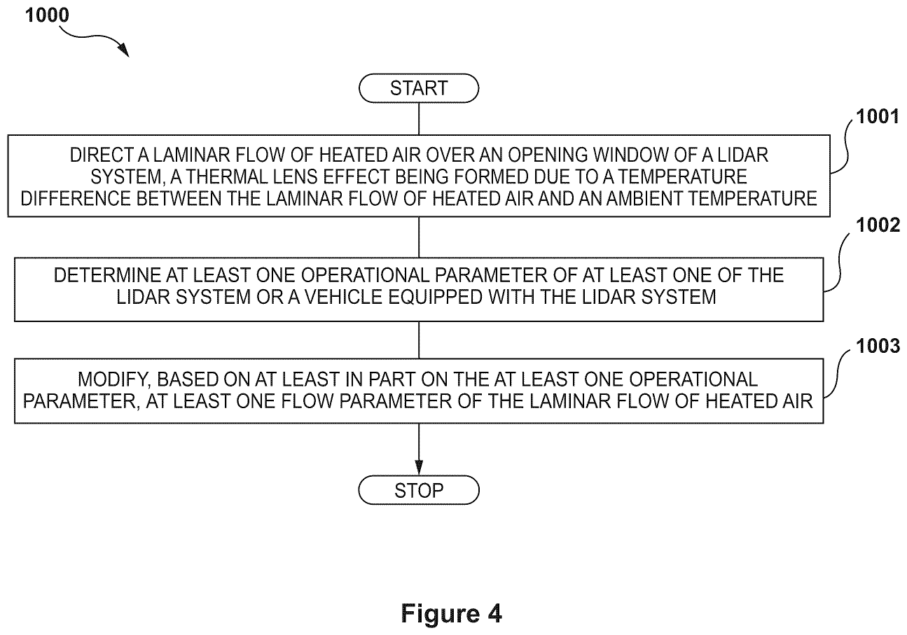

It should be noted that the LiDAR system 300 or an additional LiDAR system could be mounted in combination with one or more camera systems in a housing mounted on the top of the vehicle 220. With reference to FIG. 4, in some embodiments of the present technology, a method 1000 may be employed by the controller 100 of the LiDAR system 300 for controlling the thermal lens effect 320 for operation of the LiDAR system 300. Various steps of the method 1000 will now be described with greater detail.
STEP 1001: Direct a laminar flow of heated air over an opening window of a LiDAR system, a thermal lens effect being formed due to a temperature difference between the laminar flow of heated air and an ambient temperature.

The method 1000 begins at step 1001 with directing a laminar flow of heated air 313 over the opening window 307 of the LiDAR system 300 of FIG. 1. This creates a thermal lens effect 320, which occurs due to the difference between the temperature 312 (T_{tf}) of the heated air flow 313 and the temperature 311 of the ambient atmosphere (Tₐₐ). The laminar flow of heated air 313 helps in cleaning the surface of the opening window 307. The resultant thermal lens effect 320 modifies the optical performance of the LiDAR system 320.

In some implementations, the laminar flow could be initiated prior to operation of the LiDAR system 300. It is also contemplated that the laminar flow could be initiated during on-going operation of the LiDAR system 300, for instance in response to a detected obstruction of the window 307.
STEP 1002: Determine at least one operational parameter of at least one of the LiDAR system or a vehicle equipped with the LiDAR system.

The method 1000 continues to step 1002 with determining at least one operational parameter of the LiDAR system 300 and/or the vehicle 220 equipped with the LiDAR system 300. It is contemplated that the controller 100 of the LiDAR system 300 may employ sensors in order to obtain real-time information about these parameters.
STEP 1003: Modify, based at least in part on the at least one operational parameter, at least one flow parameter of the laminar flow of heated air.

The method 1000 proceeds to step 1003 with modifying at least one parameter of the laminar flow of heated air 313 based on the operational parameters determined in step 1002. The adjustments may involve changing the temperature, speed, pressure, or angle of the heated air flow 313.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that some of these steps may be combined, sub-divided, or re-ordered without departing from the teachings of the present technology. Accordingly, the order and grouping of the steps is not a limitation of the present technology.

1. A method for controlling a LiDAR system, the LiDAR system being associated with a vehicle, the method comprising:
directing a laminar flow of heated air over an opening window of the LiDAR system, a thermal lens effect being formed due to a temperature difference between the laminar flow of heated air and an ambient temperature;
determining at least one operational parameter of at least one of the LiDAR system or the vehicle; and
modifying, based on at least in part on the at least one operational parameter, at least one flow parameter of the laminar flow of heated air.

2. The method of claim 1, wherein the at least one operational parameter comprises at least one of: the ambient temperature; or
a driving mode of the vehicle; or
at least one performance metric of the LiDAR system.

3. The method of claim 2, wherein the modifying the at least one flow parameter comprises modifying the at least one flow parameter in response to at least one of:
a change in the ambient temperature; or
a change in the driving mode of the vehicle; or
a change in the at least one performance metric of the LiDAR system.

4. The method of claim 2, wherein the determining the at least one performance metric of the LiDAR system comprises determining at least one of:
an output beam parameter; and
an incoming beam parameter.

5. The method of claim 4, further comprising determining at least one output beam parameter, the at least one output beam parameter comprising at least one of:
an output beam pulse duration; or
an output beam angular divergence; or
an instantaneous power; or
a luminous flux at one or more distances from a light source in the LiDAR system; or
an average beam power; or
an output beam power intensity; or
an output beam width; or
an output beam repetition rate; or
an output beam sequence; or
a pulse duty cycle; or
a beam wavelength.

6. The method of claim 4, further comprising determining at least one incoming beam parameter, the at least one incoming beam parameter comprising at least one of:
a time-of-flight; or
an incoming beam instantaneous power; or
an average power across return pulses; or
a luminous flux distribution over return pulse period; or
a number of reflected beams; or
a shape of the leading edge of the incoming beam.

7. The method of claim 1, wherein the modifying the at least one flow parameter comprises:
determining the at least one operational parameter over a period of time; and
modifying the at least one flow parameter in response to a change in the at least one operational parameter during the period of time.

8. The method of claim 7, wherein:
the at least one operational parameter comprises at least one of:
the ambient temperature; or
a driving mode of the vehicle; or
at least one performance metric of the LiDAR system; and
the modifying the at least one flow parameter comprises modifying the at least one flow parameter in response to at least one of:
a change in the ambient temperature during the period of time; or
a change in the driving mode of the vehicle during the period of time; or
a change in the at least one performance metric of the LiDAR system during the period of time.

9. The method of claim 1, wherein the modifying the at least one flow parameter comprises modifying at least one of:
a temperature of the laminar flow of heated air; or
an air speed of the laminar flow of heated air; or
an air pressure of the laminar flow of heated air; or
an angle of flow of the laminar flow of heated air; or
a width of flow of the laminar flow of heated air.

10. The method of claim 1, wherein the driving mode includes at least one of:
speed variations of the vehicle; or
traffic patterns; or
characteristics of driving routes.

11. The method of claim 1, further comprising increasing a temperature difference between the laminar flow of heated air and the ambient temperature to widen a field of view of the LiDAR system for close-range detection mode.

12. The method of claim 1, further comprising decreasing a temperature difference between the laminar flow of heated air and the ambient temperature to extend a detection range of the LiDAR system for a long-range detection mode.

13. A LiDAR system comprising:
a housing including an opening window;
a scanning unit and a detecting unit disposed in the housing;
a nozzle configured to direct a laminar flow of heated air over the opening window to induce a thermal lens effect due to a temperature difference between the laminar flow of heated air and an ambient temperature; and
a control unit operatively connected to the nozzle,
the control unit being configured to:
cause the nozzle to direct the laminar flow of heated air over the opening window;
determining at least one operational parameter of at least one of the LiDAR system or a vehicle equipped with the LiDAR system; and
modifying, based at least in part on the at least one operational parameter, at least one flow parameter of the laminar flow of heated air.

14. The LiDAR system of claim 13, further comprising at least one sensor for determining the at least one operational parameter.

15. The LiDAR system of claim 14, wherein the at least one sensor comprises:
an ambient temperature sensor; and
an incoming air flow velocity sensor.

16. The LiDAR system of claim 13, wherein the control unit is further configured to modify the at least one flow parameter by modifying at least one of:
a temperature of the laminar flow of heated air; or
an air speed of the laminar flow of heated air; or
an air pressure of the laminar flow of heated air; or
an angle of flow of the laminar flow of heated air, or
a width of flow of the laminar flow of heated air.

17. The LiDAR system of claim 13, wherein the control unit is further configured to increase a temperature difference between the laminar flow of heated air and the ambient temperature to widen a field of view of the LiDAR system for close-range detection mode.

18. The LiDAR system of claim 13, wherein the control unit is further configured to decrease a temperature difference between the laminar flow of heated air and the ambient temperature to extend a detection range of the LiDAR system for a long-range detection mode.

19. The LiDAR system of claim 13, wherein the control unit is further configured to determine the at least one operational parameter by determining at least one of:
the ambient temperature; or
a driving mode of the vehicle equipped with the LiDAR system; or
at least one performance metric of the LiDAR system.
